(19) United States
(12) Patent Application Publication
(10) Pub. No.: US 2005/0280259 A1
(43) Pub. Date: Dec. 22, 2005

(54) Multilayer metallic high pressure conduit

(76) Inventors: Andreas Sausner, Frankfurt (DE); Paolo Balbi, Sori (IT); Pierluigi Picco, Recco (IT)

Correspondence Address: JENNER & BLOCK, LLP, ONE IBM PLAZA, CHICAGO, IL, 60611, US

(21) Appl. No.: 10/987,973

(22) Filed: Nov. 12, 2004

(30) Foreign Application Priority Data
Nov. 12, 2003 (DE) 203 17 565.4
Sep. 10, 2004 (EP) 04 021 542.8

(51) Int. Cl. F16L 31/00

(52) U.S. Cl. 285/288.1

(57) ABSTRACT

A multilayer metallic high-pressure conduit for a high-pressure medium, particularly for a fuel injection system in motor vehicles, comprises a metallic inner tube, at least one metallic intermediate layer and a metallic outer tube. These metallic tubes or layers are connected to one another without soldering. At least one end connector element is welded to one end of the conduit.

### BACKGROUND OF THE INVENTION

This application claims priority pursuant to Title 35 U.S.C. § 119 to German Application No. 203 17 565.4 filed Nov. 12, 2003 and EP Application No. 04 021 542.8 filed Sep. 10, 2004.

This invention pertains to a multilayer metallic high-pressure conduit for a high- pressure medium, particularly for a fuel injection system in motor vehicles. In this context, the term high-pressure conduit for a high-pressure medium refers to a conduit, through which a fluid is conveyed under a high pressure of, for example, 1.000 bar or more. The term fuel injection system for motor vehicles refers, in particular, to a diesel fuel injection system for motor vehicles.

Multilayer metallic high-pressure conduits of the aforementioned type are known from the state of the art. These high-pressure conduits consist of several metal tubes or several metallic layers that are coaxially fitted into one another. Conventional conduits usually comprises an inner tube of low-carbon steel, a metallic intermediate layer that preferably also consists of steel and an outer tube that preferably also consists of steel. The aforementioned layers of these known conduits are soldered to one another and, after being provided with a zinc coating, comprise a passivation layer containing chromium (IV) or chromium (III). Due to this connecting technique, these conduits are only suitable for pressures up to 1.300 bar. The outer tube of known high-pressure conduits, in particular, leaves something to be desired with respect to its resistance to corrosion. The outer layer is relatively weak and can be easily damaged. Naturally, this reduces the long-term resistance to corrosion. During the manipulation or the processing of the conduits, zinc particles can easily break off such that it is sometimes difficult to observe the cleanliness requirements. The external appearance of known high-pressure conduits also leaves something to be desired because of the surface of the outer tube quickly becomes dull and uneven. Known conduits are usually subjected to an autofrettage treatment in order to increase their fatigue strength under pulsating pressure conditions. This is the reason why steel with a high yield strength is preferably utilized for the inner tube. However, this material is negatively influenced during the soldering process such that its mechanical properties deteriorate. This is disadvantageous with respect to high-pressure applications. Generally speaking, the connection of the layers by means of soldering results in disadvantageous mechanical properties of known conduits. Since the material of the inner layer is negatively influenced, inside corrosion may occur, in particular, if aggressive fluids or fuels are conveyed through the conduit.

At least one end of a high-pressure conduit is provided with end connector elements for connecting the conduit to other elements of the high-pressure installation. An end connector element usually consists of a peripheral thickening or a peripheral flange that serves for holding and attaching other connecting elements, particularly a screw nut. The end connector element in the form of a peripheral thickening or a peripheral flange is produced by cold-working the conduit material in known high-pressure conduits. This cold-working requires the prior soldering of the layers, wherein said soldering process is associated with the above-described disadvantages. However, the cold-working of the conduit also impairs the inside surfaces of the conduit such that an undesirable increase in the pressure drop or uneven pressures occur when a fluid is conveyed through the conduit. In addition, the sealing surfaces on the conduit ends or the connecting region become damaged during the cold-working. This causes problems (e.g., leaks), in particular, under high pressures.

The invention is based on the objective of disclosing a multilayer metallic high-pressure conduit of the initially mentioned type that makes it possible to eliminate the above-described disadvantages and is suitable for use, in particular, under high pressures, namely while still ensuring a long-term resistance to corrosion and abrasion.

This objective is attained with a multilayer metallic high-pressure conduit for a high-pressure medium, particularly for a fuel injection system in motor vehicles, wherein a metallic inner tube, at least one metallic intermediate layer and one metallic outer tube are provided, wherein these metallic tubes or layers are connected to one another without soldering, and wherein at least one end connector element is welded to one end of the conduit.

In the context of the invention, a connection between the metallic tubes or layers without soldering means that the adjoining surfaces of these tubes or layers are not connected to one another by soldering or welding. The scope of the invention also includes embodiments, in which the metallic tubes or layers are connected by means of pressing. This means that the tubes or layers are pressed together, wherein the connection is preferably produced by cold-pressing the tubes or layers.

According to the invention, the metallic outer tube may consist of steel, preferably stainless steel. According to one particularly preferred embodiment of the invention, the metallic inner tube consists of a steel tube, preferably a stainless steel tube. According to one embodiment, a seamless steel tube or stainless steel tube may be utilized as the inner tube. According to another embodiment, a steel tube, preferably a single-rolled stainless steel tube that is welded along a longitudinal seam, is utilized as the inner tube.

The metallic intermediate layer preferably consists of at least one double-walled metal tube. According to one particular embodiment, two double-walled metal tubes may be used for the intermediate layer. These double-walled metal tubes preferably consist of double-rolled metal tubes, i.e., metal tubes rolled by an angle of 720° (degrees). However, the intermediate layer may also consist of at least one single-walled metal tube or of two or more single-walled metal tubes.

According to the invention, all layers or tubes of the high-pressure conduit according to the invention are joined or connected to one another without soldering. The layers or tubes are preferably pressed against one another during a pressing or compressing process. The high-pressure conduit according to the invention preferably is manufactured by coaxially fitting the different layers or tubes into one another and subsequently pressing together or cold-working the thusly assembled layers or tubes, namely such that the individual layers or tubes are in direct contact with one another or directly adjoin one another, respectively. The high-pressure conduit preferably is subjected to a subsequent autofrettage treatment.

According to the invention, at least one end connector element is welded to one end of the conduit. It is preferred that at least one end connector element is respectively welded to each end of the conduit. The end connector element preferably consists of a peripheral end connector element preferably consists of a peripheral end connect flange of steel or stainless steel. This end connector flange serves, in particular, for holding a screw nut for connecting the high-pressure conduit to other elements of the high-pressure installation. According to one particularly preferred embodiment of the invention, the end connector element or the end connector flange, respectively, is welded to the conduit by means of laser welding. This laser welding of the end connector element is of particular importance in the context of the invention. In this respect, it was recognized that the cold-working of the conduit ends can be eliminated.

The high-pressure conduit preferably has an outside diameter between 5 and 10 mm, preferably between 5 and 9 mm, and an inside diameter between 1.5 and 4.5 mm, preferably between 2 and 3.5 mm. The outside diameter lies, in particular, between 6 and 8 mm and the inside diameter of the high-pressure conduit according to the invention lies, in particular, between 2.3 and 3 mm.

A preferred variation of the method for manufacturing a high-pressure conduit according to the invention is described below. It was already mentioned above that the layers or tubes forming the high-pressure conduit initially should be coaxially fitted into one another. This is preferably followed by a pressing or cold-working process such that the layers or tubes are pressed against one another. This is achieved by exerting a radially inward directed pressure over the entire circumference of the thusly assembled layers or tubes. As mentioned above, a soldering process for connecting the individual layers can be eliminated. Instead, a subsequent thermal treatment may be carried out in order to control the yield strength. The inside bore can then be subjected to a fine-machining process. Subsequently, the conduit preferably is cut into conduit sections of the desired length. The conduit ends are then preferably subjected to a processing or shaping step, for example, grinding. The end connector elements or the end connector flanges can then be welded on, wherein the process is preferably carried out by means of laser welding. The conduit or conduit sections can then be bent as required. It is preferred to subsequently carry out an autofrettage treatment of the conduit. Ultimately, the conduit is preferably subjected to a cleaning process, in which lightly aggressive fluids is utilized. The inside bore may be additionally or alternatively polished.

The invention is based on the notion that a high-pressure conduit according to the invention is not only resistant to relatively high fluid pressures, but also has a high resistance to corrosion and abrasion. The entire conduit including the conduit ends has a surprisingly high long-term resistance to corrosion, namely on the inside as well as the outside and, in particular, with respect to aggressive mediums. The high-pressure conduit according to the invention, particularly the outer tube, has a high mechanical strength. In comparison with outer tubes known from the state of the art, the outer tube is also more resistant to percussions and impacts and less sensitive to scratches and cracks. An inner tube with high yield strength can be utilized due to the elimination of a soldering process. This means that excellent properties, particularly excellent mechanical properties, can be obtained after an autofrettage treatment. Since an end connector element is welded to the conduit ends, the conduit ends as well as the entire conduit have a higher mechanical strength. In comparison with the conduits known from the state of the art, the elimination of the cold-working of the conduit ends also makes it possible to prevent microscopic cracks that could lower the resistance to pressure. It should also be emphasized that the high-pressure conduit according to the invention can be realized free of undesirable chromium IV. In addition, the cleanliness requirements can be better observed with the high-pressure conduit according to the invention. In comparison with conduits known from the state of the art, undesirable zinc particles are no longer created during the manipulation, installation, removal or processing of the conduit. Since the conduit according to the invention contains an outer tube of stainless steel, the high-pressure conduit can also be effectively cleaned with more aggressive cleaning liquids. This was not possible with conduits known from the state of the art. A superior seal can be achieved in the connecting region of the high-pressure conduit according to the invention, wherein the corresponding sealing surfaces are also more consistent because they are not produced by cold-working the sealing region, but rather fine-machining. It should also be mentioned that the high-pressure conduit according to the invention has a very esthetic external appearance.

### BRIEF DESCRIPTION OF THE DRAWINGS

FIG. 1 is a longitudinal section through part of a high-pressure conduit according to the invention during the manufacturing process (cold-pressing of the layers);

FIG. 2 is a cross section through a high-pressure conduit according to the invention;

FIG. 3 is a different variation of the object shown in FIG. 2;

FIG. 4 is a longitudinal section through part of a high-pressure conduit according to the invention;

FIG. 4A is a fragmentary longitudinal plan view partially in section, showing a prior art end form; and

FIG. 5 is a perspective representation of a high-pressure conduit according to the invention.

### DETAILED DESCRIPTION OF THE DRAWINGS

The figures show a multilayer metallic high-pressure conduit according to the invention for a high-pressure medium, particularly for a fuel injection system in motor vehicles. The high-pressure conduit contains a metallic inner tube 1 that is preferably realized in the form of a seamless stainless steel tube as shown in the figures. The conduit also contains a metallic intermediate layer 2 (or intermediate layers 2), as well as a metallic outer tube 3 of stainless steel. The inner tube 1, the intermediate layer 2 (or intermediate layers 2) and the outer tube 3 are connected to one another without soldering. The three elements initially are coaxially fitted into one another and then pressed together. The process of pressing together the individual elements is illustrated in FIG. 1.

In the embodiment shown in FIG. 1, the metallic intermediate layer 2 consists of two metallic tubes (two double-walled tubes or two single-walled tubes). In the embodiment shown in FIG. 2, the metallic intermediate layer 2 is realized in the form of a double-walled metal tube. In the embodiment shown in FIG. 3, the metallic intermediate layer 2 consists of two double-walled metal tubes.

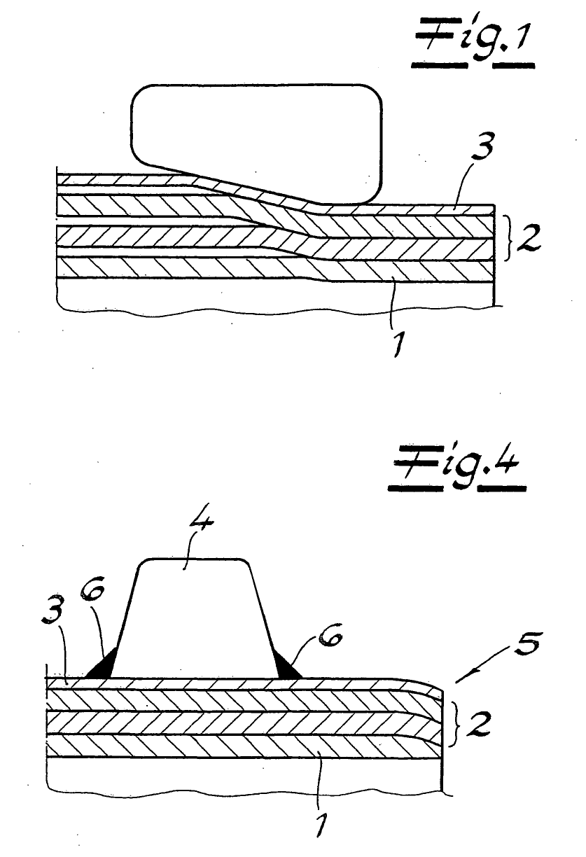

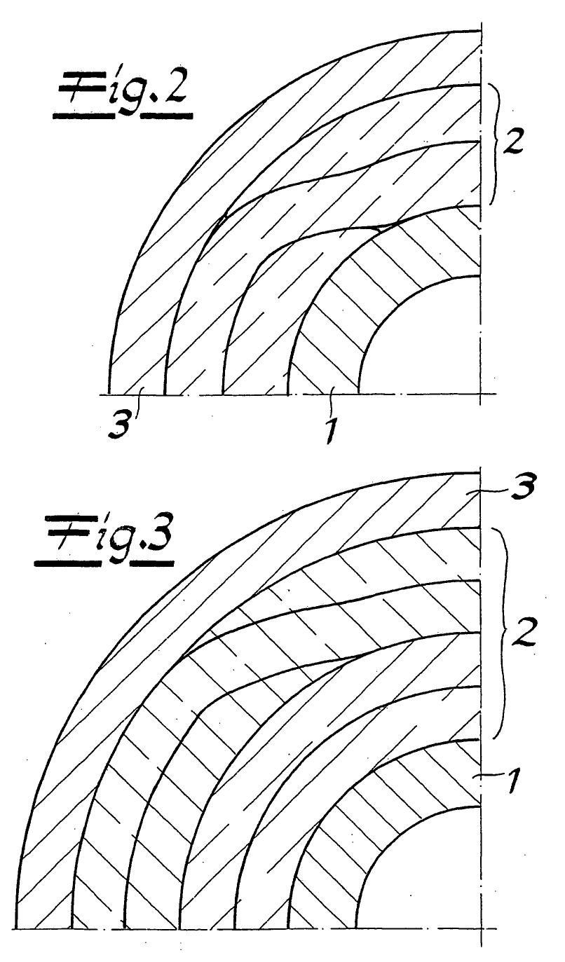

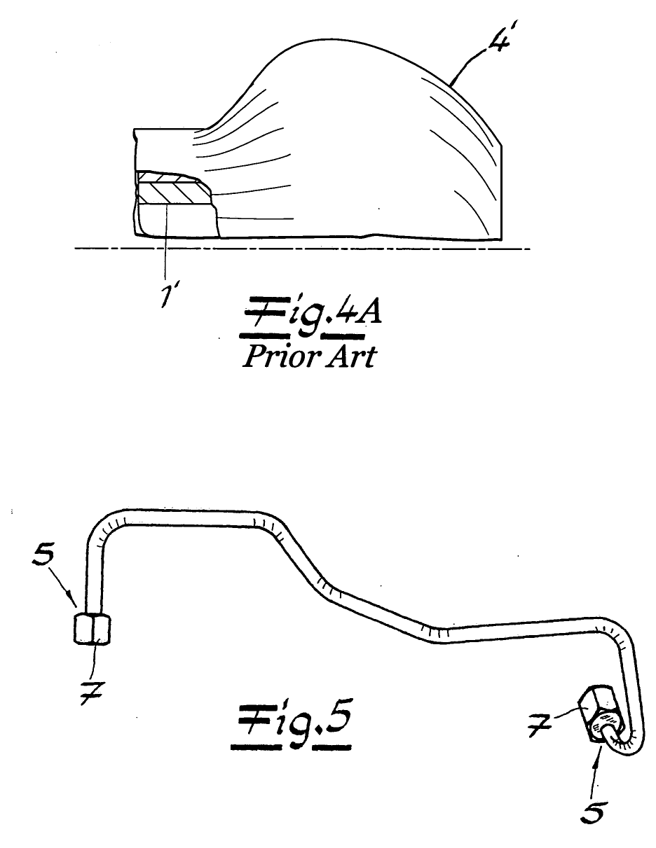

FIG. 4 shows an end connector element 4 that is welded to one end 5 of the conduit, preferably by means of laser welding. One can clearly identify the corresponding laser welding region 6. The end connector elements 4 consist of peripheral end connector flanges that extend over the circumference of the high-pressure conduit. These end connector flanges serve for holding a screw nut for connecting the end 5 of the conduit to other elements of the high-pressure installation. An end connector element 4′ on a tube 1′ manufactured in accordance with the state of the art is also illustrated in FIG. 4A. This end connector element 4′ was manufactured by means of cold-working in accordance with measures known from the state of the art.

FIG. 6 shows a perspective representation of a high-pressure conduit that was provided with corresponding bends. Screw nuts 7 are connected to both ends 5 of the high-pressure conduit.

1. A multilayer metallic high-pressure conduit for a high-pressure medium, particularly for a fuel injection system in motor vehicles,
comprising a metallic inner tube, at least one metallic intermediate layer and a metallic outer tube,
wherein these metallic tubes or layers are connected to one another without soldering, and
wherein at least one end connector element is welded to one end of the conduit.

2. The high-pressure conduit according to claim 1 wherein the metallic tubes or layers are connected by being pressed together.

3. The high-pressure conduit according to claim 2 wherein the metallic tubes or layers are connected to one another by means of cold-pressing.

4. The high-pressure conduit according to one of claims 1 wherein the metallic outer tube consists of steel, preferably stainless steel.

5. The high-pressure conduit according to one of claims 2 wherein the metallic outer tube consists of steel, preferably stainless steel.

6. The high-pressure conduit according to one of claims 3 wherein the metallic outer tube consists of steel, preferably stainless steel.

7. The high-pressure conduit according to one of claims 1 wherein the metallic inner tube consists of a steel tube, preferably a stainless steel tube.

8. The high-pressure conduit according to one of claims 2 wherein the metallic inner tube consists of a steel tube, preferably a stainless steel tube.

9. The high-pressure conduit according to one of claims 3 wherein the metallic inner tube consists of a steel tube, preferably a stainless steel tube.

10. The high-pressure conduit according to one of claims 4 wherein the metallic inner tube consists of a steel tube, preferably a stainless steel tube.

11. The high-pressure conduit according to one of claims 5 wherein the metallic inner tube consists of a steel tube, preferably a stainless steel tube.

12. The high-pressure conduit according to one of claims 6 wherein the metallic inner tube consists of a steel tube, preferably a stainless steel tube.

13. The high-pressure conduit according to one of claims 1 wherein the end connector element is welded to the conduit by means of laser welding.

14. The high-pressure conduit according to one of claims 2 wherein the end connector element is welded to the conduit by means of laser welding.

15. The high-pressure conduit according to one of claims 3 wherein the end connector element is welded to the conduit by means of laser welding.

16. The high-pressure conduit according to one of claims 4 wherein the end connector element is welded to the conduit by means of laser welding.

17. The high-pressure conduit according to one of claims 5 wherein the end connector element is welded to the conduit by means of laser welding.

18. The high-pressure conduit according to one of claims 6 wherein the end connector element is welded to the conduit by means of laser welding.

19. The high-pressure conduit according to one of claims 7 wherein the end connector element is welded to the conduit by means of laser welding.

20. The high-pressure conduit according to one of claims 8 wherein the end connector element is welded to the conduit by means of laser welding.

21. The high-pressure conduit according to one of claims 9 wherein the end connector element is welded to the conduit by means of laser welding.

22. The high-pressure conduit according to one of claims 10 wherein the end connector element is welded to the conduit by means of laser welding.

23. The high-pressure conduit according to one of claims 11 wherein the end connector element is welded to the conduit by means of laser welding.

24. The high-pressure conduit according to one of claims 12 wherein the end connector element is welded to the conduit by means of laser welding.

25. The high-pressure conduit according to one of claims 1 wherein the conduit has an outside diameter between 5 and 10 mm, preferably between 5 and 9 mm, and an inside diameter between 1.5 and 4.5 mm, preferably between 2 and 3.5 mm.

26. The high-pressure conduit according to one of claims 2 wherein the conduit has an outside diameter between 5 and 10 mm, preferably between 5 and 9 mm, and an inside diameter between 1.5 and 4.5 mm, preferably between 2 and 3.5 mm.

27. The high-pressure conduit according to one of claims 3 wherein the conduit has an outside diameter between 5 and 10 mm, preferably between 5 and 9 mm, and an inside diameter between 1.5 and 4.5mm, preferably between 2 and 3.5 mm.

28. The high-pressure conduit according to one of claims 4 wherein the conduit has an outside diameter between 5 and 10 mm, preferably between 5 and 9 mm, and an inside diameter between 1.5 and 4.5 mm, preferably between 2 and 3.5 mm.

29. The high-pressure conduit according to one of claims 5 wherein the conduit has an outside diameter between 5 and 10 mm, preferably between 5 and 9 mm, and an inside diameter between 1.5 and 4.5 mm, preferably between 2 and 3.5 mm.

30. The high-pressure conduit according to one of claims 6 wherein the conduit has an outside diameter between 5 and 10 mm, preferably between 5 and 9 mm, and an inside diameter between 1.5 and 4.5 mm, preferably between 2 and 3.5 mm.

31. The high-pressure conduit according to one of claims 7 wherein the conduit has an outside diameter between 5 and 10 mm, preferably between 5 and 9 mm, and an inside diameter between 1.5 and 4.5 mm, preferably between 2 and 3.5 mm.

32. The high-pressure conduit according to one of claims 8 wherein the conduit has an outside diameter between 5 and 10 mm, preferably between 5 and 9 mm, and an inside diameter between 1.5 and 4.5 mm, preferably between 2 and 3.5 mm.

33. The high-pressure conduit according to one of claims 9 wherein the conduit has an outside diameter between 5 and 10 mm, preferably between 5 and 9 mm, and an inside diameter between 1.5 and 4.5 mm, preferably between 2 and 3.5 mm.

34. The high-pressure conduit according to one of claims 10 wherein the conduit has an outside diameter between 5 and 10 mm, preferably between 5 and 9 mm, and an inside diameter between 1.5 and 4.5 mm, preferably between 2 and 3.5 mm.

35. The high-pressure conduit according to one of claims 11 wherein the conduit has an outside diameter between 5 and 10 mm, preferably between 5 and 9 mm, and an inside diameter between 1.5 and 4.5 mm, preferably between 2 and 3.5 mm.

36. The high-pressure conduit according to one of claims 12 wherein the conduit has an outside diameter between 5 and 10 mm, preferably between 5 and 9 mm, and an inside diameter between 1.5 and 4.5 mm, preferably between 2 and 3.5 mm.

37. The high-pressure conduit according to one of claims 13 wherein the conduit has an outside diameter between 5 and 10 mm, preferably between 5 and 9 mm, and an inside diameter between 1.5 and 4.5 mm, preferably between 2 and 3.5 mm.

38. The high-pressure conduit according to one of claims 14 wherein the conduit has an outside diameter between 5 and 10 mm, preferably between 5 and 9 mm, and an inside diameter between 1.5 and 4.5 mm, preferably between 2 and 3.5 mm.

39. The high-pressure conduit according to one of claims 15 wherein the conduit has an outside diameter between 5 and 10 mm, preferably between 5 and 9 mm, and an inside diameter between 1.5 and 4.5 mm, preferably between 2 and 3.5 mm.

40. The high-pressure conduit according to one of claims 16 wherein the conduit has an outside diameter between 5 and 10 mm, preferably between 5 and 9 mm, and an inside diameter between 1.5 and 4.5 mm, preferably between 2 and 3.5 mm.

41. The high-pressure conduit according to one of claims 17 wherein the conduit has an outside diameter between 5 and 10 mm, preferably between 5 and 9 mm, and an inside diameter between 1.5 and 4.5 mm, preferably between 2 and 3.5 mm.

42. The high-pressure conduit according to one of claims 18 wherein the conduit has an outside diameter between 5 and 10 mm, preferably between 5 and 9 mm, and an inside diameter between 1.5 and 4.5 mm, preferably between 2 and 3.5 mm.

43. The high-pressure conduit according to one of claims 19 wherein the conduit has an outside diameter between 5 and 10 mm, preferably between 5 and 9 mm, and an inside diameter between 1.5 and 4.5 mm, preferably between 2 and 3.5 mm.

44. The high-pressure conduit according to one of claims 20 wherein the conduit has an outside diameter between 5 and 10 mm, preferably between 5 and 9 mm, and an inside diameter between 1.5 and 4.5 mm, preferably between 2 and 3.5 mm.

45. The high-pressure conduit according to one of claims 21 wherein the conduit has an outside diameter between 5 and 10 mm, preferably between 5 and 9 mm, and an inside diameter between 1.5 and 4.5 mm, preferably between 2 and 3.5 mm.

46. The high-pressure conduit according to one of claims 22 wherein the conduit has an outside diameter between 5 and 10 mm, preferably between 5 and 9 mm, and an inside diameter between 1.5 and 4.5 mm, preferably between 2 and 3.5 mm.

47. The high-pressure conduit according to one of claims 23 wherein the conduit has an outside diameter between 5 and 10 mm, preferably between 5 and 9 mm, and an inside diameter between 1.5 and 4.5 mm, preferably between 2 and 3.5 mm.

48. The high-pressure conduit according to one of claims 24 wherein the conduit has an outside diameter between 5 and 10 mm, preferably between 5 and 9 mm, and an inside diameter between 1.5 and 4.5 mm, preferably between 2 and 3.5 mm.

49. The high-pressure conduit according to one of claims 1-48 wherein the conduit was subjected to an autofrettage treatment.
